(19) United States
(12) Patent Application Publication
(10) Pub. No.: US 2018/0041512 A1
(43) Pub. Date: Feb. 8, 2018

(54) NOTIFICATION FRAMEWORK FOR ACCESS POINT CONTROLLERS

(71) Applicant: Extreme Networks, Inc., San Jose, CA (US)

(72) Inventors: SUNDARESAN SUNDARAM, BANGALORE (IN); KRISHNA RAJA, BANGALORE (IN); SUBRAMANI RAJENDIRAN, BANGALORE (IN); SANDEEP RAMAKRISHNAN, BANGALORE (IN)

(21) Appl. No.: 15/227,258

(22) Filed: Aug. 3, 2016

(51) Int. Cl. H04L 29/06

(52) U.S. Cl. CPC H04L 63/10; H04L 63/08; H04L 63/029; H04W 84/12

(57) ABSTRACT

A notification framework for access point controllers is provided. An access point controller receives, from a device, a request for an application token associated with an application at the device, the application token configured to identify messages to the application when transmitted therewith. The access point controller transmits, to the device, the application token. When the device is to communicate with an applications server associated with the application, the device transmits the application token to the applications server, which transmits messages for the application to the access point controller which transmits the messages, with the application token, to the device. In response, the device can provide a notification of the message, and/or the device can establish a connection with the application server, at least temporarily.

### BACKGROUND

It can be challenging for applications servers (e.g. in the Internet) to initiate communications towards devices, including mobile devices located behind firewalls; further IP (internet protocol) addresses of such devices can be masked using NAT (network address translation) protocols. In other words, firewalls can block connections from the internet towards the devices, and the IP address of the device can change depending on the location and connectivity mode (e.g. 3G WAN (wireless area network) WLAN (wireless local area network), and the like). Hence, at a minimum, an applications server may not be configured with a current IP address of a device.

One solution to this problem is to operate a server component on each device located behind the firewall to communicate with the applications server, but such solutions can have security issues, can cause battery drain in mobile devices, and waste device memory and processing resources.

Another solution is to use notification servers, which assist applications servers to communicate with devices. In this scheme, a device, such as a mobile device, always keeps open a live socket connection towards the notification server. Hence, when an applications server generates a notification for an application at the device, the applications server transmits such a notification to a notification server which, in turn, passes the notification to the device using the live socket connection. When the notification reaches the device using the live socket connection, the operating system of the device passes the received notification to the correct application. However, such a scheme results in further overhead for the wireless network both because a notification server must be deployed therein, and because each device in the wireless network must keep open a live socket connection with the notification server, which wastes bandwidth and processing resources at each device. Such a solution can be especially problematic when deployed in mobile devices.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate implementations of concepts described herein, and explain various principles and advantages of those implementations.

FIG. 1 depicts a schematic diagram of a system for providing a notification framework for access point controllers, according to non-limiting implementations.

FIG. 2 depicts a schematic diagram of an access point controllers of the system of FIG. 1, according to non-limiting implementations.

FIG. 3 depicts a schematic diagram of an access point of the system of FIG. 1, according to non-limiting implementations.

FIG. 4 depicts a schematic diagram of a device of the system of FIG. 1, according to non-limiting implementations.

FIG. 5 depicts a schematic diagram of an applications server of the system of FIG. 1, according to non-limiting implementations.

FIG. 6 depicts a block diagram of a flowchart of a method for providing a notification framework for access point controllers, which can be implemented in an access point controller in the system of FIG. 1, according to non-limiting implementations.

FIG. 7 depicts a block diagram of a flowchart of a method for providing a notification framework for access point controllers that can be implemented in a device in the system of FIG. 1, in conjunction with the method of FIG. 6, according to non-limiting implementations.

FIG. 8 depicts a simplified version of the system of FIG. 1 to illustrate blocks of the methods of FIG. 6 and FIG. 7, according to non-limiting implementations.

FIG. 9 is similar to FIG. 8 and illustrates further blocks of the methods of FIG. 6 and FIG. 7, according to non-limiting implementations.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present specification.

The apparatus and method components have been represented where appropriate by conventional symbols in the drawings, showing only those specific details that are pertinent to understanding the implementations of the present specification so as not to obscure the disclosure with details that will be readily apparent to those of ordinary skill in the art having the benefit of the description herein.

### DETAILED DESCRIPTION

An aspect of the present specification provides an access point controller comprising: a processor, a memory and a communication interface configured to communicate with a device and an applications server using one or more access points, the processor configured to: manage the one or more access points; receive, from the device, using the communication interface, a request for an application token associated with an application at the device, the application token configured to identify messages to the application when transmitted therewith; and, transmit, to the device, using the communication interface, the application token.

The access point controller can further comprise one of a cloud controller and a local controller.

The processor can be further configured to: receive, from the applications server, using the communication interface, a message with the application token, the message intended for the application at the device; and, transmit, to the device, using the communication interface, the message with the application token. The processor can be further configured to: transmit, to the device, using the communication interface, the message with the application token using an access point, the message with the application token received at the device in an 802.11 action frame.

The processor can be further configured to communicate with the device using the one or more access points, communications with the device occurring at least according to an 802.11 protocol.

The processor can be further configured to: generate the application token.

The processor can be further configured to: store the application token at the memory in association with an identifier of the device.

Another aspect of the present specification provides a method comprising: managing, at an access point controller, one or more access points using a communication interface configured to communicate with a device and an applications server using the one or more access points; receiving, at a processor of the access point controller, from the device, using the communication interface, a request for an application token associated with an application at the device, the application token configured to identify messages to the application when transmitted therewith; and transmitting, from the access point controller, to the device, using the communication interface, the application token.

The access point controller can comprise one of a cloud controller and a local controller.

The method can further comprise: receiving, at the access point controller, from the applications server, using the communication interface, a message with the application token, the message intended for the application at the device; and, transmitting, from the access point controller, to the device, using the communication interface, the message with the application token. The method can further comprise: transmitting, from the access point controller, to the device, using the communication interface, the message with the application token using an access point, the message with the application token received at the device in an 802.11 action frame.

The method can further comprise communicating with the device using the one or more access points, communications with the device occurring at least according to an 802.11 protocol.

The method can further comprise: generating, at the access point, the application token.

The method can further comprise: storing, at a memory of the access point, the application token in association with an identifier of the device.

Another aspect of the present specification provides a computer-readable medium storing a computer program, wherein execution of the computer program is for: managing, at an access point controller, one or more access points using a communication interface configured to communicate with a device and an applications server using the one or more access points; receiving, at a processor of the access point controller, from the device, using the communication interface, a request for an application token associated with an application at the device, the application token configured to identify messages to the application when transmitted therewith; and, transmitting, from the access point controller, to the device, using the communication interface, the application token. The computer-readable medium can comprise a non-transitory computer-readable medium.

The access point controller can comprise one of a cloud controller and a local controller.

Execution of the computer program can be further for: receiving, at the access point controller, from the applications server, using the communication interface, a message with the application token, the message intended for the application at the device; and, transmitting, from the access point controller, to the device, using the communication interface, the message with the application token. Execution of the computer program can be further for: transmitting, from the access point controller, to the device, using the communication interface, the message with the application token using an access point, the message with the application token received at the device in an 802.11 action frame.

Execution of the computer program can be further for communicating with the device using the one or more access points, communications with the device occurring at least according to an 802.11 protocol.

Execution of the computer program can be further for: generating, at the access point, the application token.

Execution of the computer program can be further for: storing, at a memory of the access point, the application token in association with an identifier of the device.

Another aspect of the present specification provides a device comprising: a processor, a notification device, a memory storing an application, and a communication interface configured to communicate with an access point controller and an applications server using one or more access points, the processor configured to: transmit, to the access point controller, using the communication interface, a request for an application token associated with the application; receive, from the access point controller, using the communication interface, the application token; transmit, to the applications server, using the communication interface, the application token; and, when a message intended for the application is received with the application token from the access point controller, using the communication interface to one or more of: control the notification device to provide a notification of the message; and, establish, using the communication interface, a connection with the applications server.

The processor can be further configured to: control the notification device to provide the notification of the message by: providing the notification in association with processing the application.

The connection between the device and the applications server can comprise a temporary TCP/IP socket connection.

Another aspect of the present specification provides a method comprising: transmitting, from a device to an access point controller, a request for an application token associated with an application stored at a memory of the device, the device configured to communicate with the access point controller and an applications server using one or more access points; receiving, at the device, from the access point controller, the application token; transmitting, from the device, to the applications server; and, when a message intended for the application is received with the application token at the device from the access point controller, one or more of: controlling, at the device a notification device to provide a notification of the message; and, establishing, at the device, a connection with the applications server.

The method can further comprise: controlling the notification device to provide the notification of the message by: providing the notification in association with processing the application.

The connection between the device and the applications server can comprise a temporary TCP/IP socket connection.

Yet another aspect of the present specification provides computer-readable medium storing a computer program, wherein execution of the computer program is for: transmitting, from a device to an access point controller, a request for an application token associated with an application stored at a memory of the device, the device configured to communicate with the access point controller and an applications server using one or more access points; receiving, at the device, from the access point controller, the application token; transmitting, from the device, to the applications server; and, when a message intended for the application is received with the application token at the device from the access point controller, one or more of: controlling, at the device a notification device to provide a notification of the message; and, establishing, at the device, a connection with the applications server. The computer-readable medium can comprise a non-transitory computer-readable medium.

Execution of the computer program can be further for: controlling the notification device to provide the notification of the message by: providing the notification in association with processing the application.

The connection between the device and the applications server can comprise a temporary TCP/IP socket connection.

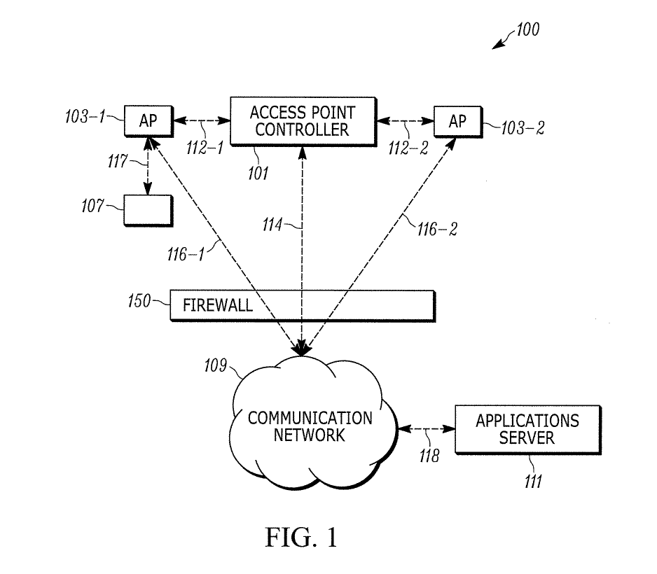

Attention is directed to FIG.1 which depicts a schematic diagram of a system 100 which provides a notification framework for access point controllers in the absence of a notification server: indeed, system 100 can enable providing notifications to devices in the absence of a notification server. System 100 comprises an access point controller 101 (interchangeably referred to herein as controller 101), one or more access points 103-1, 103-2, (interchangeably referred to hereafter, collectively, as APs 103 and, generically, as an AP 103), a device 107, a communication network 109 (interchangeably referred to herein as network 109), and an applications server 111 (interchangeably referred to herein as server 111).

While only one controller 101 is depicted in system 100, system 100 can comprises more than controller 101. Similarly, while only two APs 103 are depicted in system 100, system 100 can comprises more than two APs 103, and as few as one AP 103. Similarly, while only one device 107 is depicted in system 100, system 100 can comprises more than device 107. Indeed, system 100 can also comprise more than one applications server 111.

Components of system 100 are generally in communication using communication links, each of which will be interchangeably referred to as a link. Specifically, controller 101 is in communication with each AP 103 using a respective link 112-1, 112-2 (interchangeably referred to, collectively, as links 112 and, generically, as a link 112). Similarly, controller 101 in communication with network 109 using a link 114, each access point 103 is in communication with network using a respective link 116-1, 116-2 (interchangeably referred to, collectively, as links 116 and, generically, as a link 116), and, as depicted, device 107 in communication with AP 103-1 using a link 117. However, when device 107 moves relative to APs 103, device 107 could establish a similar link with AP 103-2 (or any other AP 103 in system 100). Similarly, server 111 is in communication with network 109 using a link 118.

Each of the depicted links can be wired and/or wireless as desired. In particular, however, link 117 can generally be wireless, for example when device 107 comprises a mobile device. Each of links 112, 114, 116, 118 can be wired, wireless and/or a combination.

Further, while as depicted, controller 101 is in communication with network 109 directly via a link 114, in other implementations, controller 101 can be in communication with network 109 via one or more APs 103; in other words, link 114 can comprise one or more of links 112, and one or more of links 116.

Indeed, controller 101 and APS 103 can, together form a wireless access network (WAN) which can include, but is not limited to, a wireless local access network (WLAN). While communication between device 107 with APs 103 will be described with respect to such a WAN operating according to an 802.11 and/or WiFi protocol, such a WAN can operate according to other protocols, including, but not limited to a 3G protocol (e.g. as a 3G WAN).

Controller 101 is generally configured to one or more of manage one or more of APs 103 (which can alternatively be referred to as controlling one or more of APs 103). Furthermore, controller 101 can comprise a local controller or a cloud controller. For example, as depicted, controller 101 is local to APs 103 (e.g. controller 101 can comprise a local controller, and APs 103 can be local-controller managed). However, controller 101 could also be located “in the cloud” and not physically located with APs 103 (e.g. controller 101 can comprise a cloud controller, and APs 103 can be cloud-controller managed); in these implementations, controller 101 can be in communication with APs 103 via network 109. Either way, controller 101 can be configured to manage one or more APs 103 by providing management parameters and/or control parameters to each AP 103 which can include, but is not limited to, an SSID (Service Set Identifier) an IP (internet protocol) address, and the like.

Each AP 103 is configured to provide wireless access to network 109 (and the like) to communication devices, mobile devices, and the like, including, but not limited to, device 107, in a communication range of each AP 103. Hence, for example, each AP 103 can comprise one or more of an 802.11 access point, a WiFi access point, a WiMax access point, and the like. As such, each AP 103 is further in communication with network 109 via a respective link 116, and is configured to convey data between communication devices, mobile devices, and the like, including, but not limited to device 107, and network 109.

Similarly, controller 101 can communicate with device 107 via one or more APs 103; for example, as depicted, controller 101 can communicate with device 107 via AP 103-1 via links 112-1, 117. In particular, controller 101 can transmit data to AP 103-1 using a first protocol, and AP 103-1 can, in turn, transmit the data to device 107 using a second protocol, converting the data received from the first protocol to the second protocol. For example, communications between controller 101 and APs 103 can occur according to a proprietary communication protocol provided by a supplier of controller 101 and APs 103, and communication between APs 103 can occur according to an 802.11 protocol. However, in other implementations communications between controller 101 and APs 103, and communications between APs 103 and device 107 can occur according to a same protocol, including, but not limited to, an 802.11 protocol.

Further depicted in FIG. 1 is a firewall 150 and at least APs 103 and device 107 can be located behind firewall 150. As such, controller 101 can comprise an edge device in the WAN which mediates communications between device 107 and server 111 through firewall 150. However, firewall 150 is not necessary for functionality of system 100. In addition, as depicted, system 100 is lacking a notification server, as compared to prior art systems.

Furthermore, a network address of device 107 can be managed and/or masked by controller 101 using a NAT (network address translation) protocol such that device 107 cannot be easily contacted by devices and/or servers external to the WAN and/or WLAN formed by APs 103 and controller 101. Indeed, whether device 107 is located behind firewall 150 and/or a network address of device 107 is managed and/or masked by controller 101 using a NAT protocol, the device address is not available to server 111, not transmitted to server 111, and/or masked from to server 111. In other words, server 111 cannot directly “see” device 107. As will be described below, in present implementations, server 111 and device 107 can communicate and/or initiate a connection there between, using an applications token, in contrast to systems where a device maintains a live socket connection with a notifications server, which mediates communications between devices and applications servers.

Each of controller 101, APs 103, device 107 and server 111 will now be described in more detail.

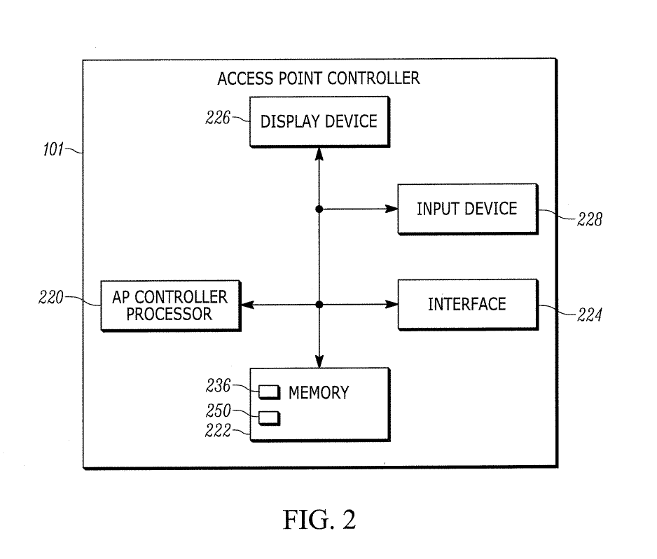

Attention is next directed to FIG.2 which depicts a schematic diagram of controller 101. Controller 101 comprises: an AP controller processor 220 (interchangeably referred to hereafter as processor 220); a memory 222; and a communication interface 224 (interchangeably referred to hereafter as interface 224). As depicted, controller 101 further comprises a display device 226 and at least one input device 228, however such components are optional. Furthermore, when present, display device 226 and input device 228 can also be external to controller 101, and processor 220 can be in communication with any such external components via a suitable connection and/or link. While not depicted, controller 101 generally further comprises a chassis and a power supply and any other components used to implement access point controller functionality.

Processor 220 is generally configured to manage (and/or control) the one or more access points 103. Such management and/or control can include, but is not limited to, client authentication (e.g. authenticating devices in communication with AP 103), group management, quality of service monitoring and management, tunneling management, firewall services and management, spectrum monitoring and analysis, and the like. Indeed, processor 220 can be generally configured to provide any controller and/or management services for one or more APs 103. In some implementations controller 101 can further manage a network address of device 107 using NAT protocol and the like.

Indeed, controller 101 can comprise any computing device suitable for providing controller and/or management services to one or more APs 103 including, but not limited to, a personal computer, a laptop computer and any suitable server device, which can be commercially available and/or specifically configured for providing controller and/or management services to one or more APs 103. In some implementations, controller 101 can comprise a DHCP (Dynamic Host Configuration Protocol) server.

Processor 220 can comprise a processor and/or a plurality of processors, including but not limited to one or more central processors (CPUs) and/or one or more processing units and/or one or more graphic processing units (GPUs); either way, processor 220 comprises a hardware element and/or a hardware processor. Indeed, in some implementations, processor 220 can comprise an ASIC (application-specific integrated circuit) and/or an FPGA (field-programmable gate array) specifically configured to implement the functionality of controller 101. In other words, processor 220 can comprise an AP controller processor, and hence, controller 101 is preferably not a generic computing device, but a device specifically configured to implement specific AP controller and/or management functionality, as well as to mediate communications between applications server 111 and device 107. For example, controller 101 and/or processor 220 can specifically comprise a computer executable engine configured to manage and/or control APs 103, as well as mediate communications between applications server 111 and device 107.

Memory 222 can comprise a non-volatile storage unit (e.g. Erasable Electronic Programmable Read Only Memory (“EEPROM”), Flash Memory) and a volatile storage unit (e.g. random access memory (“RAM”)). Programming instructions that implement the functional teachings of controller 101 as described herein are typically maintained, persistently, at memory 222 and used by processor 220 which makes appropriate utilization of volatile storage during the execution of such programming instructions. Those skilled in the art recognize that memory 222 is an example of computer readable media that can store programming instructions executable on processor 220. Furthermore, memory 222 is also an example of a memory unit and/or memory module and/or a non-volatile memory.

In particular, memory 222 can store an application 236 that, when executed by processor 220, enables processor 220 to: manage and/or control the one or more access points 103; receive, from device 107, using the communication interface 224, a request for an application token associated with an application at device 107, the application token configured to identify messages to the application when transmitted therewith; and, transmit, to device 107, using the communication interface 224, the application token. Application 236, when executed by processor 220,can further enables processor 220to: receive, from applications server 111, using the communication interface 224, a message with the application token, the message intended for the application at device 107; and, transmit, to device 107, using the communication interface 224, the message with the application token. Implementation of such functionality at controller 101 enables server 111 and device 107 to be able to communicate without device 107 having to maintain a live socket connection with a notifications server, as described in more detail below.

Furthermore, the application token that is transmitted to device 107 is generally application specific. For example, as described below, device 107 can store one or more applications that can colloquially be referred to as “apps”, and the application token is generally specific both to device 107 and to an application and/or an “app” at device 107, which can be associated with server 111. As such, controller 101 can also be generally configured to generate such an application token, which can generally comprise an identifier associated with device 107 and an application and/or an “app” at device 107; as will be described in more detail below, such an application token can be used to mediate communications between server 111 and device 107 when server 111 transmits a message intended for the associated application and/or “app” at device 107. In particular, the application token is configured to identify messages to an application when transmitted therewith, as described in further detail below.

Memory 222 further stores an identifier 250 of device 107 which can include, but is not limited to, a MAC (media access control) identifier, an IP address, and the like. Identifier 250 can be provisioned at memory 222 when device 107 registers and/or first communicates with an AP 103: for example, when such a registration and/or communication occurs, such a registration and/or communication can include device 107 providing identifier 250 to an AP 103, which in turn can provide identifier 250 to controller 101 for storage at memory 222; alternatively, identifier 250 can be assigned to device 107 by controller 101, and identifier 250 can be stored at memory 222 and transmitted to device 107 such that device 107 can later identify itself, at least to controller 101. Furthermore, identifier 250 can be used by controller 101 to communicate with device 107; in other words, identifier 250 can be used as an address of device 107 within the WAN and/or WLAN, and the like, formed by controller 101 and APs 103.

While not depicted, memory 222 can further store respective identifiers of applications at device 107 which can be provisioned at controller 101 in a manner similar to identifier 250.

While not depicted, memory 222 can further store identifiers of APs being managed and/or controlled by controller 101, as well as parameters associated with each, including, but not limited to, IP addresses, SSIDs, and the like.

As depicted, processor 220 also connects to interface 224, which can be implemented as one or more radios and/or connectors and/or network adaptors, configured to communicate wired and/or wirelessly at least to APs 103, for example using links 112, and optionally directly with one or more communication networks, including network 109, using link 114. It will be appreciated that interface 224 is configured to correspond with network architecture that is used to implement links 112, 114, including but not limited to any suitable combination of USB (universal serial bus) cables, serial cables, wireless links, cell-phone links, cellular network links (including but not limited to 2G, 2.5G, 3G, 4G+ such as UMTS (Universal Mobile Telecommunications System), GSM (Global System for Mobile Communications), CDMA (Code division multiple access), FDD (frequency division duplexing), LTE (Long Term Evolution), TDD (time division duplexing), TDD-LTE (TDD-Long Term Evolution), TD-SCDMA (Time Division Synchronous Code Division Multiple Access) and the like, wireless data, WLAN (wireless local area network) links, WiFi links, WiMax links, packet based links, the Internet, analog networks, the PSTN (public switched telephone network), access points, and the like, and/or a combination.

Processor 220 can be further configured to communicate with optional display device 226, which comprises any suitable one of, or combination of, flat panel displays (e.g. LCD (liquid crystal display),plasma displays, OLED (organic light emitting diode) displays, capacitive or resistive touchscreens, CRTs (cathode ray tubes) and the like). Processor 220 be further configured to communicate with input device 228, which is configured to receive input data; as such, input device 228 can comprise any suitable combination of input devices, including but not limited to a keyboard, a keypad, a pointing device, a mouse, a track wheel, a trackball, a touchpad, a touch screen (e.g. integrated with display device 226), and the like. Other suitable input devices are within the scope of present implementations.

Furthermore, depending on whether controller 101 is configured as a local controller or a cloud controller, controller 101 can comprise further components and/or functionality associated with local controllers or cloud controllers; alternatively controller 101 can be configured with components and/or functionality associated with both local controllers and cloud controllers, and configured for use as either a local controller or a cloud controller.

Hence, it should be understood that in general a wide variety of configurations for controller 101 are contemplated and controller 101 can include other components, including, but not limited to, a speaker, a microphone and the like.

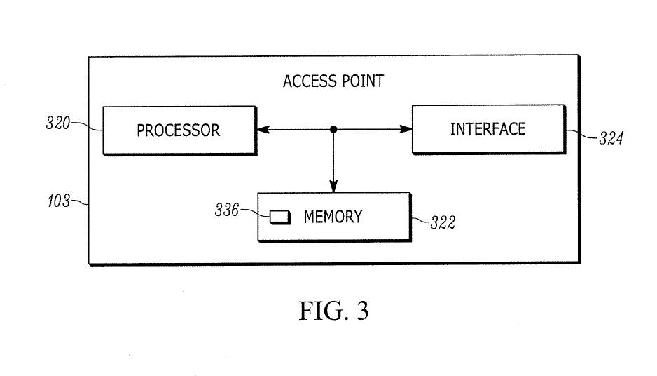

Attention is next directed to FIG. 3 which depicts a schematic diagram of an AP 103, which comprises: a processor 320; a memory 322; and a communication interface 324 (interchangeably referred to hereafter as interface 324). While not depicted, AP 103 generally further comprises a chassis and a power supply and any other components used to implement access point functionality. Each of processor 320, memory 322 and communication interface 324 is generally similar, respectively, to processor 220, memory 222 and interface 224, though adapted and/or selected and/or configured for use with AP 103. Hence, interface 324 can generally be configured to communicate wirelessly with communication devices, mobile devices, including device 107, as well communicate with controller 101, and network 109. Furthermore, processor 320 and memory 322 are selected for compatibility with AP 103, rather than for compatibility with a more complex computing environment as can exist in controller 101.

While not depicted, AP 103 can also be configured to communicate at least with neighboring APs 103, using a one or more of wired or wireless link.

Programming instructions that implement the functional teachings of AP 103 as described herein are typically maintained, persistently, at memory 322 and used by processor 320 which makes appropriate utilization of volatile storage during the execution of such programming instructions. Those skilled in the art recognize that memory 322 is an example of computer readable media that can store programming instructions executable on processor 320. Furthermore, memory 322 is also an example of a memory unit and/or memory module and/or a non-volatile memory.

Memory 322 further stores an application 336 that, when executed by processor 320, enables processor 320 to implement the functionality of AP 103 including, but not limited to, communicating controller 101 and device 107, optionally with other APs 103, relaying data between device 107 and network 109, and relaying data between controller 101 and device 107. In particular, when AP 103 communicates with controller 101 according to a first protocol, and communicates with device 107 according to a second protocol, processor 320 processing application 336 can further translate and/or convert between the first protocol and the second protocol. For example, when controller 101 transmits data to device 107, AP 103 can receive the data in the first protocol, and convert the data to the second protocol and transmit the data to device 107 in the second protocol (including but not limited to an 802.11 protocol); similarly, when device 107 transmits data to controller 101, AP 103 can receive the data in the second protocol, and convert the data to the first protocol and transmit the data to controller 101 in the first protocol (including but not limited to a proprietary protocol). In particular, AP 103 can be configured to modify an 802.11 action frame that comprises a message for an application at device 107, to include an associated application token, as described in more detail below.

While not depicted, memory 322 can further store identifiers and/or network addresses of device 107 and controller 101, which can be used to communicate therewith.

As depicted, processor 320 also connects to interface 324, which can be implemented as one or more radios and/or connectors and/or network adaptors, configured to communicate wired and/or wirelessly with one or more communication networks, including network 109, as well as communicate wired and/or wirelessly with controller 101 optionally other APs 103, and communication devices and/or mobile devices and the like, including, but not limited to, device 107. It will be appreciated that interface 324 is configured to correspond with network architecture that is used to implement one or more communication links 112, 116, 117. In particular, each AP 103 can comprise an 802.11 AP and/or a WiFi AP, and hence interface 324 can be configured to correspond with network architecture that is used to implement an 802.11 protocol, a WiFi network and/or WiFi communication link.

Hence, it should be understood that in general a wide variety of configurations for each AP 103 are contemplated and each AP 103 can include other components, including, but not limited to, a speaker, a microphone and the like.

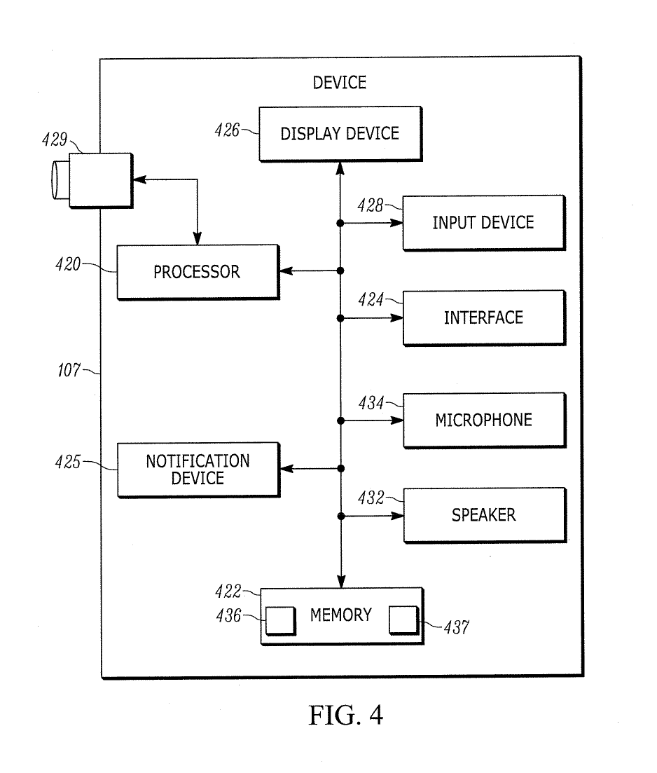

Attention is next directed to FIG. 4 which depicts a schematic diagram of a device 107, which comprises: a processor 420; a memory 422; a communication interface 424 (interchangeably referred to hereafter as interface 424), and a notification device 425. Each of processor 420, memory 422, and interface 424 is generally similar, respectively, to processor 220, memory 222 and interface 224, though adapted and/or selected and/or configured for use with device 107. Hence, interface 424 can generally be configured to communicate wirelessly, and not in a wired manner and is generally compatible with link 117; interface 424 is hence generally configured to communicate using a similar protocol to APs 103. However, in other implementations, interface 424 can generally be configured to communicate in a wired manner.

As depicted, device 107 further comprises a display device 426, at least one input device 428, an optional camera device 429, an optional speaker 432 and an optional microphone 434. While not depicted, device 107 further comprises a chassis and/or a housing, as well as a battery, a power pack and the like, which powers components of device 107 including, but not limited to, processor 420 and interface 424. Device 107 can further include a connector for powering device 107 from a mains power supply and the like, and for charging a battery, a power pack and the like.

Indeed, device 107 can generally comprise a mobile device, including, but not limited to, any suitable combination of electronic devices, communications devices, computing devices, personal computers, laptop computers, portable electronic devices, mobile computing devices, portable computing devices, tablet computing devices, laptop computing devices, desktop phones, telephones, PDAs (personal digital assistants), cellphones, smartphones, e-readers, internet-enabled appliances, mobile camera devices and the like that are specially configured to communicate with controller 101 via an AP 103, and with server 111. Other suitable devices are within the scope of present implementations. For example, device 107 can comprise a device with specialized functions, for example a device having warehouse inventory tracking and/or other data acquisition functionality, such as a mobile scanner having one or more of radio frequency identification (RFID) reader, Near Field Communication (NFC) reader, imager, and/or laser-based scanner data acquisition components. In yet further implementations, device 107 can be mountable in a vehicle configured for movement relative to APs 103.

While a specific physical configuration of device 107 is depicted in FIG. 1 (e.g. as a portable and/or mobile electronic device), other physical configurations of device 107 are within the scope of present implementations. For example, device 107 can further include one or more handles, as well as a trigger for triggering the data acquisition components and the like.

Programming instructions that implement the functional teachings of device 107 as described herein are typically maintained, persistently, at memory 422 and used by processor 420 which makes appropriate utilization of volatile storage during the execution of such programming instructions.

As depicted, memory 422 stores two applications: application 436 which, when executed by processor 420, enables processor 420 to communicate with controller 101 and server 111; and an application 437 associated with server 111.

For example, server 111 can be configured to determine when events associated with application 437 occur, and transmit messages associated with application 437 to device 107, as described below. Such messages can comprise push messages and/or push notifications intended for application 437, but notifications of such messages can be provided at device 107 without processor 420 specifically processing application 437; notifications of messages intended for application 437 can be provided using notification device 425.

While not depicted, application 437 and/or memory 422 can further store a network address and/or an identifier of server 111 such that device 107 can transmit an application thereto and/or establish communications with server 111. Such network address and/or an identifier of server 111 can be stored in application 437 and/or provisioned at memory 422 when application 437 is installed at device 107.

In particular, device 107 and/or processor 420 can be generally enabled to establish, using interface 424, a connection with server 111 which can include, but is not limited to, a TCP/IP (Transmission Control Protocol/Internet Protocol) socket connection.

As such, memory 422 further stores application 436 that, when executed by processor 420, enables processor 420 to: transmit, to access point controller 101, using communication interface 424, a request for an application token associated with application 437; receive, from access point controller 101, using communication interface 424, the application token; transmit, to application 437 server, using communication interface 424, the application token, the application token configured to identify messages to application 437 when transmitted therewith; and, when a message intended for application 437 is received with application token from access point controller 101, using communication interface 424 one or more of: control the notification device 425 to provide a notification of the message; and, establish, using communication interface 424, a connection with applications server 111. In some implementations, processor 420 can control notification device 425 to provide the notification of the message by: providing the notification in association with processing application 437.

Further, while application 436 is described specifically with respect to providing messages for application 437, memory 422 can store a plurality of applications similar to application 437, each of the plurality of applications associated with a respective applications server, which can include, but is not limited to, server 111. For example, each of the plurality of applications, including application 437, can comprise what can colloquially be referred to as an “app”, each associated with a respective applications server operated by an entity that has provided and/or provisioned the “app”. As such, processor 420 processing application 436 within system 100 can provide, at least in part, a framework for providing notifications of messages to “apps” without the use of a notification server.

Notification device 425 can comprise one or more of a display device, including, but not limited to display device 426, a light (including, but not limited to an LED (light emitting device)), a speaker, including, but not limited to speaker 432, a haptic device and the like. Further, while notification device 425 is depicted as a distinct component of device 107, when notification device 425 comprises display device 426 and/or speaker 432, notification device 425 can be integrated therewith.

Hence, it should be understood that in general a wide variety of configurations for device 107 are contemplated.

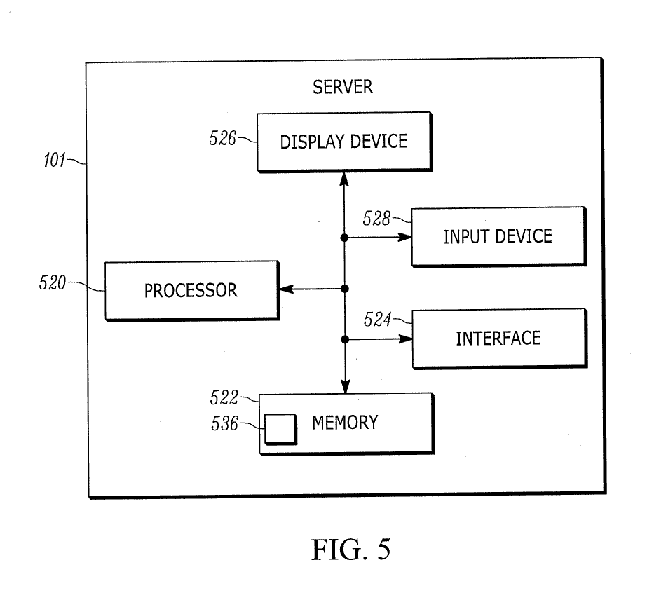

Attention is next directed to FIG. 5 which depicts a schematic diagram of server 111, which comprises: a processor 520; a memory 522; and communication interface 524 (interchangeably referred to hereafter as interface 524. While not depicted, server 111 generally further comprises a chassis and a power supply and any other components used to implement server functionality. In some implementations, as depicted, server 111 can further comprise a display device 526 and one or more input devices 528, though such components are generally optional and/or external to server 111. Each of processor 520, memory 522 and interface 524 is generally similar, respectively, to processor 220, memory 222 and interface 224, though adapted and/or selected and/or configured for use with server 111.

Hence, processor 520, memory 522 and interface 524 are generally adapted for use in server environments, and server 111 can comprise any type of server which can be used in conjunction with application 437 and/or one or more “apps” at device 107 and/or other devices which have also been provisioned with application 437. As such, server 111 can be operated by an entity that has provided and/or provisioned application 437. As such, while present implementations are described with respect to server 111 communicating with controller 101 and device 107 in association with providing messages intended for application 437 at device 107, server 111 can provide messages intended for application 437 installed at a plurality of devices which can include, but is not limited to device 107.

Interface 524 can generally be configured to communicate in a wired or wireless manner with controller 101 and device 107 using links 114, 116, 117, 118 and network 109. As will be described below, server 111 and/or interface 524 is further configured to establish a connection with device 107.

Programming instructions that implement the functional teachings of server 111 as described herein are typically maintained, persistently, at memory 522 and used by processor 520 which makes appropriate utilization of volatile storage during the execution of such programming instruction.

As such, memory 522 further stores application 536 that, when executed by processor 520, enables processor 520 to: track events associated with application 437 at device 107, as well as events associated with application 437 at devices other than device 107; receive, from device 107, an application token associated with device 107 and application 437, the application token configured to identify messages to application 437 when transmitted therewith; when an event associated with application 437 at device 107 occurs, transmit, to controller 101, a message intended for application 437 with the application token; and, in response to transmitting the message with the application token to controller 101, establish using communication interface, a connection with device 107. Such a connection can include, but is not limited to, a TCP/IP socket connection. Furthermore, such a connection can be established when server 111 receives a request from device 107 to establish the connection, such a request received in response to server 111 transmitting the message with the application token.

Further, such a process can be used to communicate with a plurality of devices, including, but not limited to, device 107, without using an intervening notification server. As such, server 111 can store, at memory 522, one or more application tokens associated with devices and/or accounts of application 437. In other words, server 111 can also store an identifier for each installation of application 437 in system 100, however such an identifier does not necessarily include an address of each device and/or such an identifier cannot necessarily be used to establish communications with an associated device, as such associated devices (including, but not limited to device 107) can be located behind a firewall and/or addresses of such devices can be masked using a NAT protocol.

As such, in the prior art, applications servers rely on notification servers to communicate with such associated devices (including, but not limited to device 107) when events associated with application 437 occur; however, presently, such communications can be enabled using application tokens, and using controller 101 to mediate such communications.

While server 111 is described with respect to providing messages intended for one application 437, in other implementations server 111 can be configured to provide messages for a plurality of applications.

Furthermore, server 111 is generally enabled to track events associated with application 437. Such events can include, but are not limited to: upgrades and/or updates to application 437, and version control/tracking; timed events associated with application 437, including, but not limited to, calendar events, and the like; receiving messages associated with application 437, for example when application 437 comprises a messaging application. Indeed, it should be understood that in general a wide variety of configurations for application 437 are contemplated, for example configurations associated with “apps”, and as such a wide variety of events associated with application 437 are contemplated that can trigger messages and/or push messages and/or push notifications associated with application 437. Indeed, functionality of event tracking at server 111, and messages intended for application 437, can depend on the functionality of application 437, and it is contemplated that server 111 is configured for tracking events associated with such functionality.

Hence, it should be understood that in general a wide variety of configurations for server 111 are contemplated.

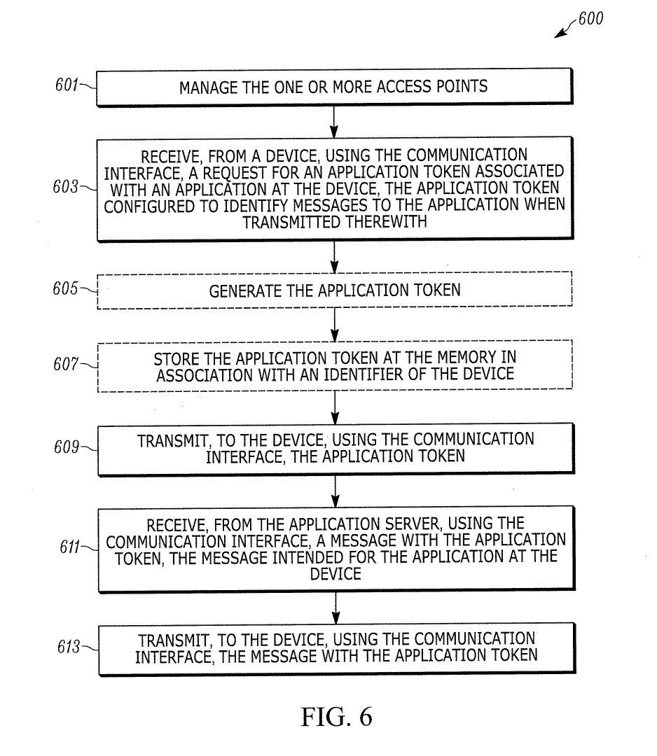

Attention is now directed to FIG. 6 which depicts a block diagram of a flowchart of a method 600 for providing a notification framework for access point controllers, according to non-limiting implementations. In order to assist in the explanation of method 600, it will be assumed that method 600 is performed using controller 101, and specifically by processor 220 at controller 101, when processor 220 processes instructions stored at memory 222, for example application 236. Indeed, method 600 is one way in which controller 101 can be configured. Furthermore, the following discussion of method 600 will lead to a further understanding of controller 101, and its various components, as well as system 100. However, it is to be understood that controller 101 and/or method 600 and/or system 100 can be varied, and need not work exactly as discussed herein in conjunction with each other, and that such variations are within the scope of present implementations.

Regardless, it is to be emphasized, that method 600 need not be performed in the exact sequence as shown, unless otherwise indicated; and likewise various blocks may be performed in parallel rather than in sequence; hence the elements of method 600 are referred to herein as “blocks” rather than “steps”. It is also to be understood, however, that method 600 can be implemented on variations of controller 101 and system 100 as well.

It is assumed in method 600 that controller 101 comprises processor 220, memory 222, and communication interface 224 configured to communicate with a device (including, but not limited to, device 107) and an applications server (including, but not limited to, server 111) using one or more access points (including, but not limited to, APs 103).

Furthermore, certain blocks of method 600 can be optional, as described below, and such optionality is indicated in FIG. 6 using broken lines for respective optional blocks.

At block 601, processor 220 one or more of manages and controls the one or more access points 103; as such, block 601 is generally directed towards access point controller functionality of controller 101 and hence can occur in parallel and/or in conjunction with other blocks of method 600

At block 603, processor 220 receives, from device 107, using communication interface 224, a request for an application token associated with an application at device 107, including, but not limited to, application 437.

At optional block 605, processor 220 generates the application token.

At optional block 607, processor 220 stores the application token at memory 222 in association with identifier 250 of device 107.

At block 609, processor 220 transmits, to device 107, using communication interface 224, the application token.

At block 611, processor 220 receives, from applications server 111, using communication interface 224, a message with the application token, the message intended for the application (such as application 437) at device 107.

At block 613, processor 220 transmits, to device 107, using communication interface 224, the message with the application token.

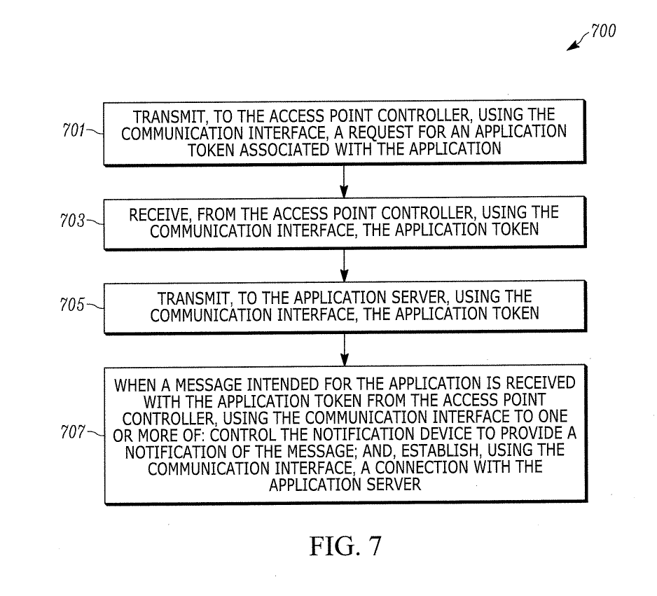

Attention is now directed to FIG. 7 which depicts a block diagram of a flowchart of a method 700 for providing a notification framework for access point controllers that can occur in system 100 in conjunction with method 600, according to non-limiting implementations. In order to assist in the explanation of method 700, it will be assumed that method 700 is performed using device 107, and specifically by processor 420 at device 107, when processor 420 processes instructions stored at memory 422, for example application 436. Indeed, method 700 is one way in which device 107 can be configured. Furthermore, the following discussion of method 700 will lead to a further understanding of device 107, and its various components, as well as system 100. However, it is to be understood that device 107 and/or method 700 and/or system 100 can be varied, and need not work exactly as discussed herein in conjunction with each other, and that such variations are within the scope of present implementations.

Regardless, it is to be emphasized, that method 700 need not be performed in the exact sequence as shown, unless otherwise indicated; and likewise various blocks may be performed in parallel rather than in sequence; hence the elements of method 700 are referred to herein as “blocks” rather than “steps”. It is also to be understood, however, that method 700 can be implemented on variations of device 107 and system 100 as well.

It is assumed in method 700 that device 107 comprises processor 420, notification device 425, memory 222 storing application 437, and communication interface 424 configured to communicate with an access point controller (including but not limited to access point controller 101) and an applications server (including but not limited to server 111) using one or more access points (including but not limited to APs 103).

At block 701 processor 420 transmits, to access point controller 101, using communication interface 424, a request for an application token associated with application 437.

At block 703 processor 420 receives, from access point controller 101, using communication interface 424, the application token.

At block 705 processor 420 transmits, to applications server 111, using communication interface 424, the application token.

At block 707 processor 420, when a message intended for the application is received with the application token from access point controller 101, using communication interface 424, one or more of: control notification device 425 to provide a notification of the message; and, establish, using communication interface 424, a connection with applications server 111.

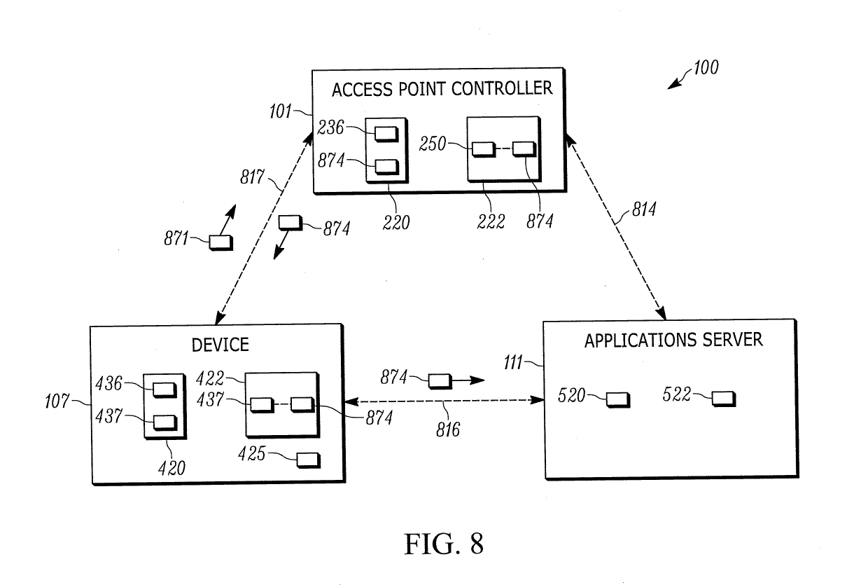

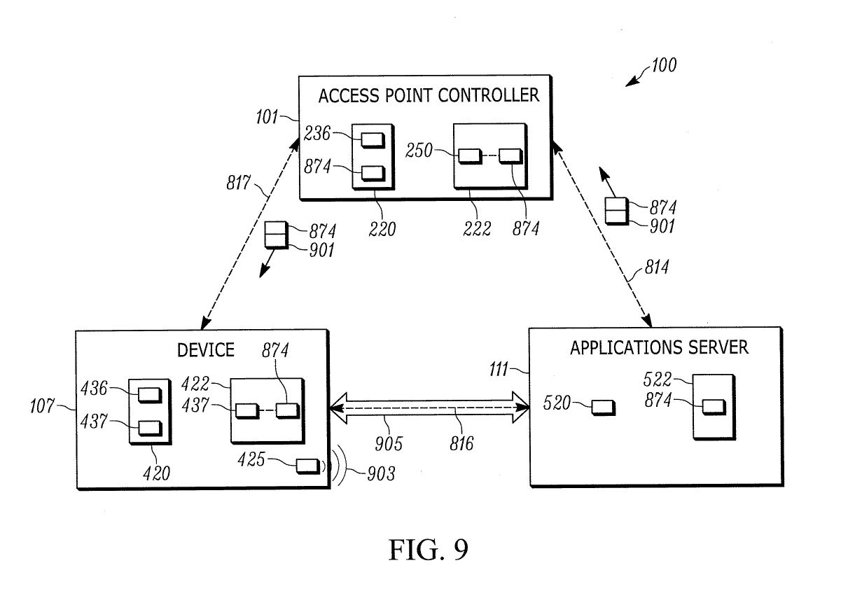

Method 600 and method 700 will now be described with respect to FIG. 8 to FIG. 9, each of which depicts a simplified version of system 100, and specifically controller 101, device 107 and server 111 using links 814, 816, 817 to communicate. For example, link 814 is between controller 101 and server 111, link 816 is between device 107 and server 111, and link 817 is between controller 101 and device 107. Each of links 814, 816, 817 includes respective links described with respect to FIG. 1, as well as one or more APs 103. When a link 814, 816, 817 includes an AP 103, it is further assumed that such an AP 103 can mediate communications between controller 101, device 107 and server 111, such an AP 103 converting between protocols as described above. For example, data and/or messages transmitted from controller 101 to device 107 can be received at device 107 in an 802.11 action frame from an AP 103, regardless of the protocol used between controller 101 and APs 103.

FIG. 8 and FIG. 9 further depict simplified versions of each of controller 101, device 107 and server 111, showing only respective processors and memories, as well as notification device 425 at device 107. It is nonetheless assumed in FIG. 8 and FIG. 9 that all components of system 100 are present, as well as all components of each controller 101, device 107 and server 111.

It is further assumed in FIG. 8 and FIG. 9 that controller 101 is implementing block 601 of method 600 on an on-going basis, and/or as required, to manage APs 103; implementations of block 601 can include, but is not limited to, client authentication (e.g. authenticating devices in communication with an AP 103), group management, quality of service monitoring and management, tunneling management, firewall services and management, spectrum monitoring and analysis, and the like.

Attention is hence next directed to FIG. 8, which depicts non-limiting implementations of blocks 603 to 609 of method 600, and blocks 701 to 705 of method 700.

In particular, device 107 transmits (e.g. at block 701) to controller 101 a request 871 for an application token associated with application 437. For example, request 871 can be transmitted when application 437 is installed and/or provisioned at device 107 and/or when application 437 is processed for a first time at device 107 such that processor 420 processing application 437 (as depicted in FIG. 8) attempts to register application 437 at server 111.

Hence, while not depicted, device 107 an also transmit to server 111, registration data associated with application 437 and/or account data associated with application 437. Such registration data and/or account data can also be stored at server 111. Indeed registration data and/or account data can be provisioned at device 107 and/or server 111 when application 437 is registered at server 111. However, registration of application 437 need not occur between device 107 and server 111. For example, instances of application 437 can be installed across a plurality of devices associated with a same account and/or user, and hence registration of application 437 for a given account can occur using a device different from device 107.

Either way, as processor 420 can also be processing application 436 when application 437 is first processed at device 107, device 107 transmits request 871 to controller 101 rather than opening a socket connection (and/or a long-lived socket connection) with a notification server (which may not be present in system 100).

Request 871 can include an identifier of device 107 (e.g. identifier 250) and an identifier of application 437, which can include, but is not limited to, an alphanumeric identifier of application 437, registration data associated with application 437, account data associated with application 437, and the like.

Request 871 is received at controller 101 (e.g. at block 603), which is processing application 236. When controller 101 and/or processor 220 receives request 871, processor 420 can generate an application token 874 (e.g. at block 605) and store application token 874 at memory 222 in association with identifier 250 of device 107 (e.g. at block 607).

Application token 874 can be generated in any suitable manner, which can include, but is not limited to, one or more of combining identifier 250 and an identifier of application 437 (e.g. as received with request 871), concatenating identifier 250 and an identifier of application 437, performing a hash process on identifier 250 and an identifier of application 437, and the like. As identifier 250 can generally be unique to device 107, and as an identifier of application 437 can generally be unique to the instance of application 437 at device 107, application token 874 can also be unique, and/or at least computationally unique within the bounds of any hash functions used to generate application token 874.

Alternatively, memory 222 can be provisioned with a plurality of tokens (not depicted) (for example when processing application 236 and/or such tokens can be received at controller 101 from an external device (not depicted) configured to generate tokens) each of which can be unique, and one of the tokens can be assigned to application 437 at device 107 as application token 874. Alternatively, upon receipt of request 871, controller 101 can request application token 874 from an external device (not depicted) configured to generate tokens.

Furthermore, FIG. 8 depicts controller 101 storing application token 874 at memory 222 in association with identifier 250 of device 107 (the association indicated by a broken line between application token 874 and identifier 250). However, controller 101 need not maintain application token 874 at memory 222 at least after implementation of block 707 of method 700. Hence application token 874 can be temporarily stored in a buffer of processor 220 without storing application token 874 at memory 222.

Regardless, in response to receiving request 871, controller 101 transmits application token 874 to device 107 (e.g. at block 609); for example, application token 874 can be transmitted to an AP 103 in communication with both controller 101 and device 107, and application token 874 can be received at device 107 in an 802.11 action frame, the AP 103 incorporating application token 874 regardless of a protocol used to communicate between controller 101 and APs 103.

Device 107 receives application token 874 (e.g. at block 703), and optionally stores application token 874 in association with application 437. In response to receiving application token 874, device 107 transmits application token 874 to server 111 (e.g. at block 705). While not depicted, application token 874 can be transmitted with an identifier of device 107 and/or registration data and/or account data.

Attention is next directed to FIG. 9, which depicts non-limiting implementations of blocks 611, 613 of method 600, and block 707 of method 700.

In particular, server 111 has received application token 874, as described with reference to FIG. 8, and stored application token 874 at memory 522. While not depicted, application token 874 can be stored in association with data that is also associated with application 437 at device 107, including, but not limited to, account data, registration data and the like.

In any event, when server 111 detects an event associated with application 437 at device 107, server 111 can generate a message 901 intended for application 437 at device 107; server 111 can transmit message 901 with application token 874 to controller 101. Message 901 can include, but is not limited to, one or more of a push message and a push notification.

Controller 101 receives (e.g. at block 611) message 901 with application token 874 from server 111. In response, controller 101 compares application token 874 to application token 874 stored at memory 222 to determine that message 901 is intended for device 107 associated with identifier 250. Controller 101 hence transmits (e.g. at block 613) message 901, with application token 874, to device 107 using, for example, identifier 250. Method 600 can then end, and any data associated with implementation of method 600 that has been stored at memory 222 (such as application token 874) can optionally be deleted.

In particular, processor 220 can transmit, to device 107, message 901 with application token 874 using an AP 103. As described above, AP 103 can communicate with each of device 107 and controller 101 using different protocols and can translate there between. In particular non-limiting implementations, processor 220 is further configured to communicate with device 107 using one or more APs 103, and communications with device 107 can occurring at least according to an 802.11 protocol, for example at least between device 107 and an AP 103. Hence, processor can be further configured to transmit, to device 107 message 901 with application token 874 using an access point 103, message 901 with application token 874 received at device 107 in an 802.11 action frame, an AP 103 incorporating message 901 with application token 874 into an 802.11 action frame when message 901 with application token 874 is received in a different protocol. For example at least application token 874 can be incorporated into a header of an 802.11 action frame.

Hence, in present implementations, an 802.11 action frame can be modified to include application token 874 to indicate that a message in the 802.11 action frame is associated with application 437.

Device 107 receives message 901 with application token 874; as message 901 is received with application token 874, which is also stored at memory 422 in association with application 874, device 107 can determine that message 901 is intended for application 437. In other words, application token 874 is configured to identify messages to application 437 when transmitted therewith. Hence, device 107 and/or processor 420 can (e.g. at block 707) one or more of: control notification device 425 to provide a notification 903 of message 901; and, establish a connection 905 with applications server 111.

Indeed, it is contemplated that notification 903 and connection 905 can be provided independent of one another and/or in conjunction with one another.

Notification 903, when present, can comprise one or more of a visual notification at display device 426, an aural communication from speaker 432, a visual notification at a light, and the like, a haptic and/or vibratory notification at a haptic device, and the like. Connection 905, when present, can be established using link 816, and can comprise an TCP/IP socket connection. Connection 905 can be later terminated when communications associated with message 901 have been completed, as determined by device 107 and/or server 111. Hence, in contrast to a long-lived socket connection, connection 905 can be established temporarily and/or only while communications device 107 and/or server 111, associated with message 901, are ongoing. Hence, connection 905 can comprise a temporary connection, and/or a temporary TCP/IP socket connection (e.g. as compared to a long-lived socket connection and/or a long-lived TCP/IP socket connection).

Furthermore, by maintaining application token 874 at least at server 111 and controller 101, after connection 905 is terminated, connection 905 can again be established by repeating at least blocks 611 to 613 of method 600, and block 707 of method 700. For example, when another message intended for application 437 at device 107 is generated at server 111, server 111 can again transmit the message with application token 874 to controller 101, which can again transmit the message with application token 874 to controller 101 to device 107, which can again one or more of provide a notification 903 of the message at notification device 425 and/or again establish connection 905.

Alternatively, rather than establish connection 905, device 107 can request additional data from server 111 over link 816 by including application token 874 in such requests, and server 111 can transmit responses to such requests to controller 101 with application token 874. Presuming the association between application token 874 and identifier 250 of device 107 is maintained at controller 101 when method 600 is completed, controller 101 can continue to mediate communications between device 107 and server 111 by transmitting, to device 107, any further data received from server 111 with application token 874.

Indeed, as content is distributed in system 100 at least in the form of message 901, system 100 can also be referred to as a content distribution system and each component of system 100, as well as methods 600, 700 can be configured for use with a content distribution system.

Hence, provided herein are devices, methods and a system for providing a notification framework for access point controllers such that access point controller can be used to mediate communications between an applications server and devices, especially when such devices are located behind a firewall and/or whose network addresses are assigned according to a NAT protocol, such that their networks addresses can change and/or are not persistent. Furthermore, use of the notification framework for access point controllers described herein can obviate a need for notification servers, as well as can obviate a need for a long-lived socket connection between devices and such notification servers.

In the foregoing specification, specific implementations have been described. However, one of ordinary skill in the art appreciates that various modifications and changes can be made without departing from the scope of the specification as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, language of “at least one of X, Y, and Z” and “one or more of X, Y and Z” can be construed as X only, Y only, Z only, or any combination of two or more items X, Y, and Z (e.g., XYZ, XY, XZ, YZ, and the like). Similar logic can be applied for two or more items in any occurrence of “at least one . . . ” and “one or more . . . ” language.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting implementation the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some implementations may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an implementation can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus the following claims are hereby incorporated into the Detailed Description, with each claim standing on its own as a separately claimed subject matter.

We claim:

1. An access point controller comprising:
a processor, a memory and a communication interface configured to communicate with a device and an applications server using one or more access points, the processor configured to:
manage the one or more access points;
receive, from the device, using the communication interface, a request for an application token associated with an application at the device, the application token configured to identify messages to the application when transmitted therewith; and,
transmit, to the device, using the communication interface, the application token.

2. The access point controller of claim 1, further comprising one of a cloud controller and a local controller.

3. The access point controller of claim 1, wherein the processor is further configured to:
receive, from the applications server, using the communication interface, a message with the application token, the message intended for the application at the device; and,
transmit, to the device, using the communication interface, the message with the application token.

4. The access point controller of claim 3, wherein the processor is further configured to: transmit, to the device, using the communication interface, the message with the application token using an access point, the message with the application token received at the device in an 802.11 action frame.

5. The access point controller of claim 1, wherein the processor is further configured to communicate with the device using the one or more access points, communications with the device occurring at least according to an 802.11 protocol.

6. The access point controller of claim 1, wherein the processor is further configured to: generate the application token.

7. The access point controller of claim 1, wherein the processor is further configured to: store the application token at the memory in association with an identifier of the device.

8. A method comprising:
managing, at an access point controller, one or more access points using a communication interface configured to communicate with a device and an applications server using the one or more access points;
receiving, at a processor of the access point controller, from the device, using the communication interface, a request for an application token associated with an application at the device, the application token configured to identify messages to the application when transmitted therewith; and,
transmitting, from the access point controller, to the device, using the communication interface, the application token.

9. The method of claim 8, wherein the access point controller comprises one of a cloud controller and a local controller.

10. The method of claim 8, further comprising:
receiving, at the access point controller, from the applications server, using the communication interface, a message with the application token, the message intended for the application at the device; and,
transmitting, from the access point controller, to the device, using the communication interface, the message with the application token.

11. The method of claim 10, further comprising: transmitting, from the access point controller, to the device, using the communication interface, the message with the application token using an access point, the message with the application token received at the device in an 802.11 action frame.

12. The method of claim 8, further comprising communicating with the device using the one or more access points, communications with the device occurring at least according to an 802.11 protocol.

13. The method of claim 8, further comprising: generating, at the access point, the application token.

14. The method of claim 8, further comprising: storing, at a memory of the access point, the application token in association with an identifier of the device.

15. A device comprising:
a processor, a notification device, a memory storing an application, and a communication interface configured to communicate with an access point controller and an applications server using one or more access points, the processor configured to:
transmit, to the access point controller, using the communication interface, a request for an application token associated with the application;
receive, from the access point controller, using the communication interface, the application token;
transmit, to the applications server, using the communication interface, the application token; and,
when a message intended for the application is received with the application token from the access point controller, using the communication interface to one or more of: control the notification device to provide a notification of the message; and, establish, using the communication interface, a connection with the applications server.

16. The device of claim 15, wherein the processor is further configured to: control the notification device to provide the notification of the message by: providing the notification in association with processing the application.

17. The device of claim 15, wherein the connection between the device and the applications server comprises a temporary TCP/IP socket connection.
